(19) United States
(12) Patent Application Publication
(10) Pub. No.: US 2026/0129219 A1
(43) Pub. Date: May 7, 2026

(54) METHOD, APPARATUS, AND MEDIUM FOR VISUAL DATA PROCESSING

(71) Applicant: Bytedance Inc., Los Angeles, CA (US)

(72) Inventors: Zhaobin ZHANG, Los Angeles, CA (US); Semilh ESENLIK, Los Angeles, CA (US); Kai ZHANG, Los Angeles, CA (US); Li ZHANG, Los Angeles, CA (US)

(21) Appl. No.: 19/437,116

(22) Filed: Dec. 30, 2025

Related U.S. Application Data
(63) Continuation of application No. PCT/US2024/036171, filed on Jun. 28, 2024.
(60) Provisional application No. 63/511,431, filed on Jun. 30, 2023.

(51) Int. Cl. H04N 19/30; G06T 9/00; H04N 19/88

(52) U.S. Cl. CPC H04N 19/30; G06T 9/002; H04N 19/88

(57) ABSTRACT

Embodiments of the present disclosure provide a solution for visual data processing. A method for visual data processing is proposed. The method comprises: performing a conversion between visual data and a bitstream of the visual data with a neural network (NN)-based model, all of upsampling components in the NN-based model being implemented with a same structure.

### CROSS REFERENCE

This application is a continuation of International Application No. PCT/US2024/036171, filed on Jun. 28, 2024, which claims the benefit of U.S. Provisional Application No. 63/511,431, filed on Jun. 30, 2023. The entire contents of these applications are hereby incorporated by reference in their entireties.

### FIELDS

Embodiments of the present disclosure relates generally to visual data processing techniques, and more particularly, to neural network-based visual data coding.

### BACKGROUND

The past decade has witnessed the rapid development of deep learning in a variety of areas, especially in computer vision and image processing. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable rate-distortion (R-D) performance with Versatile Video Coding (VVC). With the performance of neural image compression continually being improved, neural network-based video compression has become an actively developing research area. However, coding efficiency of neural network-based image/video coding is generally expected to be further improved.

### SUMMARY

Embodiments of the present disclosure provide a solution for visual data processing.

In a first aspect, a method for visual data processing is proposed. The method comprises: performing a conversion between visual data and a bitstream of the visual data with a neural network (NN)-based model, all of upsampling components in the NN-based model being implemented with a same structure.

Based on the method in accordance with the first aspect of the present disclosure, all of upsampling components in the NN-based model are implemented with a same structure. Compared with the conventional solution where upsampling components in the NN-based model are implemented with multiple types of structures, the proposed method can advantageously unify the implementation of upsampling components in the NN-based model, and thus simplify the implementation of the NN-based model. Thereby, the coding efficiency can be improved.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of visual data which is generated by a method performed by an apparatus for visual data processing. The method comprises: performing a conversion between visual data and a bitstream of the visual data with a neural network (NN)-based model, all of upsampling components in the NN-based model being implemented with a same structure.

In a fifth aspect, a method for storing a bitstream of visual data is proposed. The method comprises: generating the bitstream of the visual data with a neural network (NN)-based model, all of upsampling components in the NN-based model being implemented with a same structure; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1A illustrates a block diagram that illustrates an example visual data coding system, in accordance with some embodiments of the present disclosure;

FIG. 1B is a schematic diagram illustrating an example transform coding scheme;

FIG. 2 illustrates example latent representations of an image;

FIG. 3 is a schematic diagram illustrating an example autoencoder implementing a hyperprior model;

FIG. 4 is a schematic diagram illustrating an example combined model configured to jointly optimize a context model along with a hyperprior and the autoencoder;

FIG. 5 illustrates an example encoding process;

FIG. 6 illustrates an example decoding process;

FIG. 7 illustrates an example of pixel shuffle with r=2;

FIG. 8 illustrates an example convolutional layer;

FIG. 9 illustrates an example convolutional layer with 2 groups;

FIG. 10 illustrates an example end-to-end neural network image compression framework;

FIG. 11 illustrates an example with all upsampling units listed in Table 2 implemented with 2×2 convolution with pixel shuffle;

FIG. 12 illustrates an example 2×2 convolution with pixel shuffle is applied to Hyper Scale Decoder (base and high) and Hyper Decoder;

FIG. 13 illustrates an example 2×2 convolution with pixel shuffle is applied to Hyper Scale Decoder (base and high) and synthesis transforms (base and high);

FIG. 14 illustrates an example 2×2 convolution with pixel shuffle is applied to Hyper Scale Decoder (base and high);

FIG. 15 illustrates a flowchart of a method for visual data processing in accordance with embodiments of the present disclosure; and

FIG. 16 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

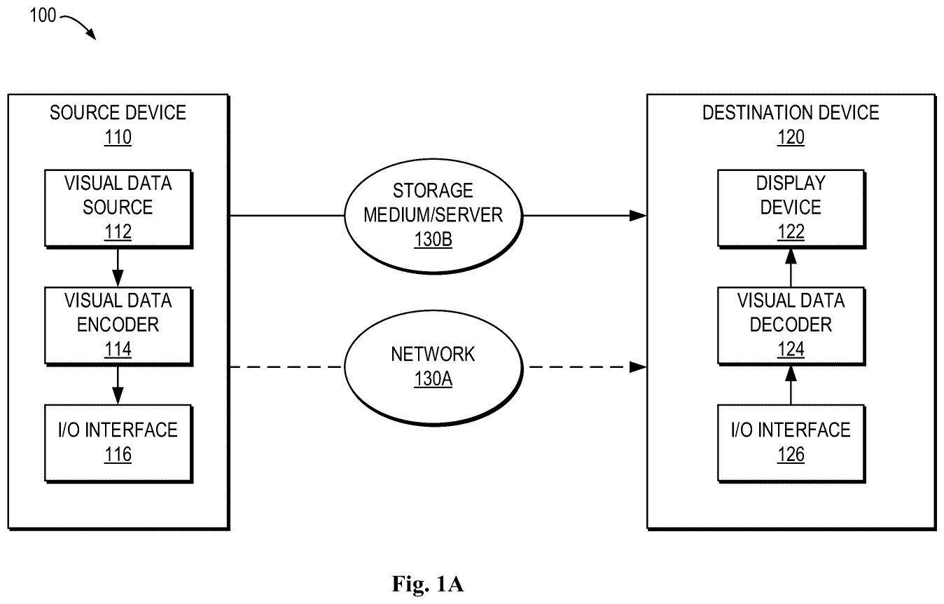

FIG. 1A is a block diagram that illustrates an example visual data coding system 100 that may utilize the techniques of this disclosure. As shown, the visual data coding system 100 may include a source device 110 and a destination device 120. The source device 110 can be also referred to as a visual data encoding device, and the destination device 120 can be also referred to as a visual data decoding device. In operation, the source device 110 can be configured to generate encoded visual data and the destination device 120 can be configured to decode the encoded visual data generated by the source device 110. The source device 110 may include a visual data source 112, a visual data encoder 114, and an input/output (I/O) interface 116.

The visual data source 112 may include a source such as a visual data capture device. Examples of the visual data capture device include, but are not limited to, an interface to receive visual data from a visual data provider, a computer graphics system for generating visual data, and/or a combination thereof.

The visual data may comprise one or more pictures of a video or one or more images. The visual data encoder 114 encodes the visual data from the visual data source 112 to generate a bitstream. The bitstream may include a sequence of bits that form a coded representation of the visual data. The bitstream may include coded pictures and associated visual data. The coded picture is a coded representation of a picture. The associated visual data may include sequence parameter sets, picture parameter sets, and other syntax structures. The I/O interface 116 may include a modulator/demodulator and/or a transmitter. The encoded visual data may be transmitted directly to destination device 120 via the I/O interface 116 through the network 130A. The encoded visual data may also be stored onto a storage medium/server 130B for access by destination device 120.

The destination device 120 may include an I/O interface 126, a visual data decoder 124, and a display device 122. The I/O interface 126 may include a receiver and/or a modem. The I/O interface 126 may acquire encoded visual data from the source device 110 or the storage medium/server 130B. The visual data decoder 124 may decode the encoded visual data. The display device 122 may display the decoded visual data to a user. The display device 122 may be integrated with the destination device 120, or may be external to the destination device 120 which is configured to interface with an external display device.

The visual data encoder 114 and the visual data decoder 124 may operate according to a visual data coding standard, such as video coding standard or still picture coding standard and other current and/or further standards.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific visual data codecs, the disclosed techniques are applicable to other coding technologies also. Furthermore, while some embodiments describe coding steps in detail, it will be understood that corresponding steps decoding that undo the coding will be implemented by a decoder. Furthermore, the term visual data processing encompasses visual data coding or compression, visual data decoding or decompression and visual data transcoding in which visual data are represented from one compressed format into another compressed format or at a different compressed bitrate.

### 1. Initial Discussion

This patent document is related to a neural network-based image and video compression method comprising an auto-regressive subnetwork, and an entropy coding engine, wherein entropy coding is performed independently of the auto-regressive subnetwork, namely the decoupled architecture. In this framework, there are multiple components that include upsampling operations but implemented with different ways. In this disclosure, a unified method is provided to make all the upsampling implementations follow a unified prototype.

### 2. Further Discussion

Deep learning is developing in a variety of areas, such as in computer vision and image processing. Inspired by the successful application of deep learning technology to computer vision areas, neural image/video compression technologies are being studied for application to image/video compression techniques. The neural network is designed based on interdisciplinary research of neuroscience and mathematics. The neural network has shown strong capabilities in the context of non-linear transform and classification. An example neural network-based image compression algorithm achieves comparable R-D performance with Versatile Video Coding (VVC), which is a video coding standard developed by the Joint Video Experts Team (JVET) with experts from motion picture experts group (MPEG) and Video coding experts group (VCEG). Neural network-based video compression is an actively developing research area resulting in continuous improvement of the performance of neural image compression. However, neural network-based video coding is still a largely undeveloped discipline due to the inherent difficulty of the problems addressed by neural networks.

### 2.1 Image/Video Compression

Image/video compression usually refers to a computing technology that compresses video images into binary code to facilitate storage and transmission. The binary codes may or may not support losslessly reconstructing the original image/video. Coding without data loss is known as lossless compression and coding while allowing for targeted loss of data in known as lossy compression, respectively. Most coding systems employ lossy compression since lossless reconstruction is not necessary in most scenarios. Usually the performance of image/video compression algorithms is evaluated based on a resulting compression ratio and reconstruction quality. Compression ratio is directly related to the number of binary codes resulting from compression, with fewer binary codes resulting in better compression. Reconstruction quality is measured by comparing the reconstructed image/video with the original image/video, with greater similarity resulting in better reconstruction quality.

Image/video compression techniques can be divided into video coding methods and neural-network-based video compression methods. Video coding schemes adopt transform-based solutions, in which statistical dependency in latent variables, such as discrete cosine transform (DCT) and wavelet coefficients, is employed to carefully hand-engineer entropy codes to model the dependencies in the quantized regime. Neural network-based video compression can be grouped into neural network-based coding tools and end-to-end neural network-based video compression. The former is embedded into existing video codecs as coding tools and only serves as part of the framework, while the latter is a separate framework developed based on neural networks without depending on video codecs.

A series of video coding standards have been developed to accommodate the increasing demands of visual content transmission. The international organization for standardization (ISO)/International Electrotechnical Commission (IEC) has two expert groups, namely Joint Photographic Experts Group (JPEG) and Moving Picture Experts Group (MPEG). International Telecommunication Union (ITU) telecommunication standardization sector (ITU-T) also has a Video Coding Experts Group (VCEG), which is for standardization of image/video coding technology. The influential video coding standards published by these organizations include Joint Photographic Experts Group (JPEG), JPEG 2000, H.262, H.264/advanced video coding (AVC) and H.265/High Efficiency Video Coding (HEVC). The Joint Video Experts Team (JVET), formed by MPEG and VCEG, developed the Versatile Video Coding (VVC) standard. An average of 50% bitrate reduction is reported by VVC under the same visual quality compared with HEVC.

Neural network-based image/video compression/coding is also under development. Example neural network coding network architectures are relatively shallow, and the performance of such networks is not satisfactory. Neural network-based methods benefit from the abundance of data and the support of powerful computing resources, and are therefore better exploited in a variety of applications. Neural network-based image/video compression has shown promising improvements and is confirmed to be feasible. Nevertheless, this technology is far from mature and a lot of challenges should be addressed.

### 2.2 Neural Networks

Neural networks, also known as artificial neural networks (ANN), are computational models used in machine learning technology. Neural networks are usually composed of multiple processing layers, and each layer is composed of multiple simple but non-linear basic computational units. One benefit of such deep networks is a capacity for processing data with multiple levels of abstraction and converting data into different kinds of representations. Representations created by neural networks are not manually designed. Instead, the deep network including the processing layers is learned from massive data using a general machine learning procedure. Deep learning eliminates the necessity of handcrafted representations. Thus, deep learning is regarded useful especially for processing natively unstructured data, such as acoustic and visual signals. The processing of such data has been a longstanding difficulty in the artificial intelligence field.

### 2.3 Neural Networks for Image Compression

Neural networks for image compression can be classified in two categories, including pixel probability models and auto-encoder models. Pixel probability models employ a predictive coding strategy. Auto-encoder models employ a transform-based solution. Sometimes, these two methods are combined together.

### 2.3.1 Pixel Probability Modeling

According to Shannon's information theory, the optimal method for lossless coding can reach the minimal coding rate, which is denoted as −log₂ p(x) where p(x) is the probability of symbol x. Arithmetic coding is a lossless coding method that is believed to be among the optimal methods. Given a probability distribution p(x), arithmetic coding causes the coding rate to be as close as possible to a theoretical limit −log₂ p(x) without considering the rounding error. Therefore, the remaining problem is to determine the probability, which is very challenging for natural image/video due to the curse of dimensionality. The curse of dimensionality refers to the problem that increasing dimensions causes data sets to become sparse, and hence rapidly increasing amounts of data is needed to effectively analyze and organize data as the number of dimensions increases.

Following the predictive coding strategy, one way to model p(x) is to predict pixel probabilities one by one in a raster scan order based on previous observations, where x is an image, can be expressed as follows:

$$p ( x ) = p ( {x}_{1} ) p ( {x}_{2} \vert {x}_{1} ) ... p ( {x}_{i} \vert {x}_{1} , ... , {x}_{i - 1} ) ... p ( {x}_{m \times n} \vert {x}_{1} , ... , {x}_{m \times n - 1} ) \qquad ( 1 )$$

where m and n are the height and width of the image, respectively. The previous observation is also known as the context of the current pixel. When the image is large, estimation of the conditional probability can be difficult. Thereby, a simplified method is to limit the range of the context of the current pixel as follows:

$$p ( x ) = p ( {x}_{1} ) p ( {x}_{2} \vert {x}_{1} ) ... p ( {x}_{i} \vert {x}_{i - k} , ... , {x}_{i - 1} ) ... p ( {x}_{m \times n} \vert {x}_{m \times n - k} , ... , {x}_{m \times n - 1} ) \qquad ( 2 )$$

where k is a pre-defined constant controlling the range of the context.

It should be noted that the condition may also take the sample values of other color components into consideration. For example, when coding the red (R), green (G), and blue (B) (RGB) color component, the R sample is dependent on previously coded pixels (including R, G, and/or B samples), the current G sample may be coded according to previously coded pixels and the current R sample. Further, when coding the current B sample, the previously coded pixels and the current R and G samples may also be taken into consideration.

Neural networks may be designed for computer vision tasks, and may also be effective in regression and classification problems. Therefore, neural networks may be used to estimate the probability of p(xᵢ) given a context x₁, x₂, . . . , xᵢ₋₁. The pixel probability is employed for binary images according to xᵢ∈{−1,+1}. The neural autoregressive distribution estimator (NADE) is designed for pixel probability modeling. NADE is a feed-forward network with a single hidden layer. In another example, the feed-forward network may include connections skipping the hidden layer. Further, the parameters may also be shared. Experiments have been performed on the binarized MNIST dataset. In an example, NADE is extended to a real-valued NADE (RNADE) model, where the probability p(xᵢ|x₁, . . . , xᵢ₋₁) is derived with a mixture of Gaussians. The RNADE model feed-forward network also has a single hidden layer, but the hidden layer employs rescaling to avoid saturation and uses a rectified linear unit (ReLU) instead of sigmoid. In another example, NADE and RNADE are improved by using reorganizing the order of the pixels and with deeper neural networks.

Designing advanced neural networks plays an important role in improving pixel probability modeling. In an example neural network, a multi-dimensional long short-term memory (LSTM) is used. The LSTM works together with mixtures of conditional Gaussian scale mixtures for probability modeling. LSTM is a special kind of recurrent neural networks (RNNs) and may be employed to model sequential data. The spatial variant of LSTM may also be used for images later. Several different neural networks may be employed, including recurrent neural networks (RNNs) and convolutional neural networks (CNNs), such as Pixel RNN (PixelRNN) and Pixel CNN (PixelCNN), respectively. In PixelRNN, two variants of LSTM, denoted as row LSTM and diagonal bidirectional LSTM (BiLSTM) are employed. Diagonal BiLSTM is specifically designed for images. PixelRNN incorporates residual connections to help train deep neural networks with up to twelve layers. In PixelCNN, masked convolutions are used to adjust for the shape of the context. PixelRNN and PixelCNN are more dedicated to natural images. For example, PixelRNN and PixelCNN consider pixels as discrete values (e.g., 0, 1, . . . , 255) and predict a multinomial distribution over the discrete values. Further, PixelRNN and PixelCNN deal with color images in RGB color space. In addition, PixelRNN and PixelCNN work well on the large-scale image dataset image network (ImageNet). In an example, a Gated PixelCNN is used to improve the PixelCNN. Gated PixelCNN achieves comparable performance with PixelRNN, but with much less complexity. In an example, a PixelCNN++ is employed with the following improvements upon PixelCNN: a discretized logistic mixture likelihood is used rather than a 256-way multinomial distribution; down-sampling is used to capture structures at multiple resolutions; additional short-cut connections are introduced to speed up training; dropout is adopted for regularization; and RGB is combined for one pixel. In another example, PixelSNAIL combines casual convolutions with self-attention.

Most of the above methods directly model the probability distribution in the pixel domain. Some designs also model the probability distribution as conditional based upon explicit or latent representations. Such a model can be expressed as:

$$p ( x \vert h ) = {\prod }_{i = 1}^{m \times n} p ( {x}_{i} \vert {x}_{1} , ... , {x}_{i - 1} , h ) \qquad ( 3 )$$

where h is the additional condition and p(x)=p(h)p(x|h) indicates the modeling is split into an unconditional model and a conditional model. The additional condition can be image label information or high-level representations.

### 2.3.2 Auto-Encoder

An Auto-encoder is now described. The auto-encoder is trained for dimensionality reduction and include an encoding component and a decoding component. The encoding component converts the high-dimension input signal to low-dimension representations. The low-dimension representations may have reduced spatial size, but a greater number of channels. The decoding component recovers the high-dimension input from the low-dimension representation. The auto-encoder enables automated learning of representations and eliminates the need of hand-crafted features, which is also believed to be one of the most important advantages of neural networks.

FIG. 1B is a schematic diagram illustrating an example transform coding scheme. The original image x is transformed by the analysis network gₐ to achieve the latent representation y. The latent representation y is quantized (q) and compressed into bits. The number of bits R is used to measure the coding rate. The quantized latent representation ŷ is then inversely transformed by a synthesis network gₛ to obtain the reconstructed image \hat{x}. The distortion (D) is calculated in a perceptual space by transforming x and \hat{x} with the function gₚ, resulting in z and \hat{z}, which are compared to obtain D.

An auto-encoder network can be applied to lossy image compression. The learned latent representation can be encoded from the well-trained neural networks. However, adapting the auto-encoder to image compression is not trivial since the original auto-encoder is not optimized for compression, and is thereby not efficient for direct use as a trained auto-encoder. In addition, other major challenges exist. First, the low-dimension representation should be quantized before being encoded. However, the quantization is not differentiable, which is required in backpropagation while training the neural networks. Second, the objective under a compression scenario is different since both the distortion and the rate need to be take into consideration. Estimating the rate is challenging. Third, a practical image coding scheme should support variable rate, scalability, encoding/decoding speed, and interoperability. In response to these challenges, various schemes are under development.

An example auto-encoder for image compression using the example transform coding scheme can be regarded as a transform coding strategy. The original image x is transformed with the analysis network y=gₐ(x), where y is the latent representation to be quantized and coded. The synthesis network inversely transforms the quantized latent representation ŷ back to obtain the reconstructed image x=gₛ(ŷ). The framework is trained with the rate-distortion loss function, [symbol] =D+λR, where D is the distortion between x and \hat{x}, R is the rate calculated or estimated from the quantized representation ŷ, and λ is the Lagrange multiplier. D can be calculated in either pixel domain or perceptual domain. Most example systems follow this prototype and the differences between such systems might only be the network structure or loss function.

In terms of network structure, RNNs and CNNs are the most widely used architectures. In the RNNs relevant category, an example general framework for variable rate image compression uses RNN. The example uses binary quantization to generate codes and does not consider rate during training. The framework provides a scalable coding functionality, where RNN with convolutional and deconvolution layers performs well. Another example offers an improved version by upgrading the encoder with a neural network similar to PixelRNN to compress the binary codes. The performance is better than JPEG on a Kodak image dataset using multi-scale structural similarity (MS-SSIM) evaluation metric. Another example further improves the RNN-based solution by introducing hidden-state priming. In addition, an SSIM-weighted loss function is also designed, and a spatially adaptive bitrates mechanism is included. This example achieves better results than better portable graphics (BPG) on the Kodak image dataset using MS-SSIM as evaluation metric.

Another example proposes a general framework for rate-distortion optimized image compression. The example system uses multinary quantization to generate integer codes and considers the rate during training. The loss is the joint rate-distortion cost, which can be mean square error (MSE) or other metrics. The example system adds random uniform noise to stimulate the quantization during training and uses the differential entropy of the noisy codes as a proxy for the rate. The example system uses generalized divisive normalization (GDN) as the network structure, which includes a linear mapping followed by a nonlinear parametric normalization. The effectiveness of GDN on image coding is verified. Another example system includes improved version of GDN that uses three convolutional layers each followed by a down-sampling layer and a GDN layer as the forward transform. Accordingly, this example version uses three layers of inverse GDN each followed by an up-sampling layer and convolution layer to stimulate the inverse transform. In addition, an arithmetic coding method is devised to compress the integer codes. The performance is reportedly better than JPEG and JPEG 2000 on Kodak dataset in terms of MSE. Another example improves the method by devising a scale hyper-prior into the auto-encoder. The system transforms the latent representation y with a subnet hₐ to z=hₐ(y) and z is quantized and transmitted as side information. Accordingly, the inverse transform is implemented with a subnet hₛ that decodes from the quantized side information \hat{z} to the standard deviation of the quantized ŷ, which is further used during the arithmetic coding of ŷ. On the Kodak image set, this method is slightly worse than BGP in terms of peak signal to noise ratio (PSNR). Another example system further explores the structures in the residue space by introducing an autoregressive model to estimate both the standard deviation and the mean. This example uses a Gaussian mixture model to further remove redundancy in the residue. The performance is on par with VVC on the Kodak image set using PSNR as evaluation metric.

### 2.3.3 Hyper Prior Model

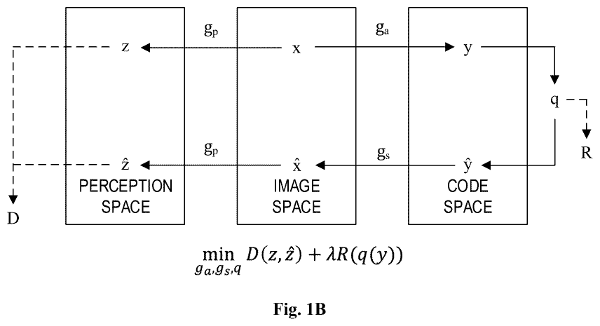

FIG. 2 illustrates example latent representations of an image. FIG. 2 includes an image from the Kodak dataset, visualization of the latent representation y of the image, a standard deviations σ of the latent, and latents y after a hyper prior network is introduced. A hyper prior network includes a hyper encoder and decoder. In the transform coding approach to image compression, as shown in FIG. 1B, the encoder subnetwork transforms the image vector x using a parametric analysis transform gₐ(x, Ø_{g}) into a latent representation y, which is then quantized to form ŷ. Because ŷ is discrete-valued, ŷ can be losslessly compressed using entropy coding techniques such as arithmetic coding and transmitted as a sequence of bits.

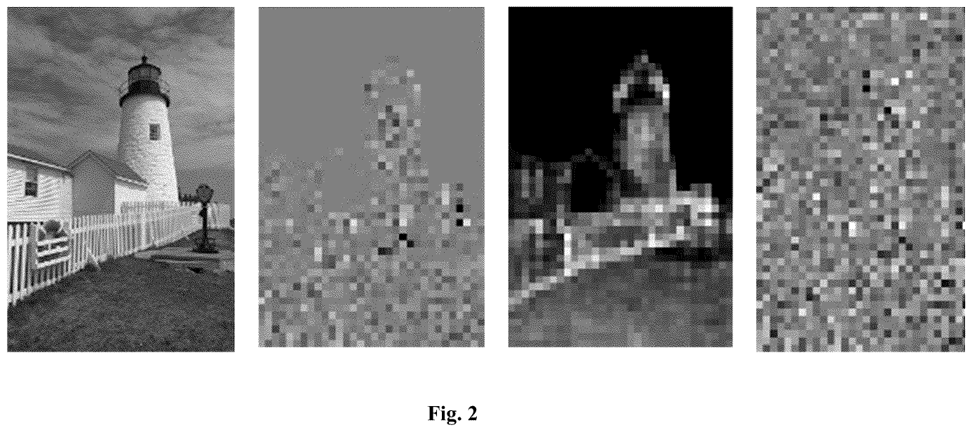

As evident from the latent and the standard deviations σ of FIG. 2, there are significant spatial dependencies among the elements of ŷ. Notably, their scales (standard deviations σ) appear to be coupled spatially. An additional set of random variables \hat{z} may be introduced to capture the spatial dependencies and to further reduce the redundancies. In this case the image compression network is depicted in FIG. 3.

FIG. 3 is a schematic diagram illustrating an example network architecture of an autoencoder implementing a hyperprior model. The upper side shows an image autoencoder network, and the lower side corresponds to the hyperprior subnetwork. The analysis and synthesis transforms are denoted as gₐ and gₛ. Q represents quantization, and AE, AD represent arithmetic encoder and arithmetic decoder, respectively. The hyperprior model includes two subnetworks, hyper encoder (denoted with hₐ) and hyper decoder (denoted with hₛ). The hyper prior model generates a quantized hyper latent (\hat{z}) which comprises information related to the probability distribution of the samples of the quantized latent ŷ. \hat{z} is included in the bitstream and transmitted to the receiver (decoder) along with ŷ.

In FIG. 3, the upper side of the models is the encoder gₐ and decoder gₛ as discussed above. The lower side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses σ to compress and transmit the quantized image representation ŷ. The decoder first recovers \hat{z} from the compressed signal. The decoder then uses hₛ to obtain σ, which provides the decoder with the correct probability estimates to successfully recover ŷ as well. The decoder then feeds ŷ into gₛ to obtain the reconstructed image.

When the hyper encoder and hyper decoder are added to the image compression network, the spatial redundancies of the quantized latent ŷ are reduced. The latents y in FIG. 2 correspond to the quantized latent when the hyper encoder/decoder are used. Compared to the standard deviations σ, the spatial redundancies are significantly reduced as the samples of the quantized latent are less correlated.

### 2.3.4 Context Model

Although the hyperprior model improves the modelling of the probability distribution of the quantized latent ŷ, additional improvement can be obtained by utilizing an autoregressive model that predicts quantized latents from their causal context, which may be known as a context model.

The term auto-regressive indicates that the output of a process is later used as an input to the process. For example, the context model subnetwork generates one sample of a latent, which is later used as input to obtain the next sample.

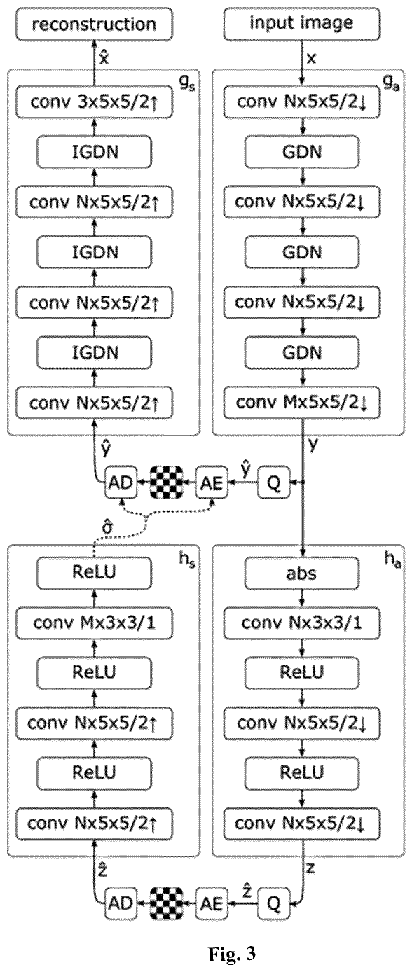

FIG. 4 is a schematic diagram illustrating an example combined model configured to jointly optimize a context model along with a hyperprior and the autoencoder. The following Table 1 illustrates meaning of different symbols.

TABLE 1
Illustration of symbols

| Component | Symbol |
|---|---|
| Input Image | [symbol] |
| Encoder | [symbol] ( [symbol] ; θₑ) |
| Latents | [symbol] |
| Latents (quantized) | [symbol] |
| Decoder | [symbol] ( [symbol] ; θ_{d}) |
| Hyper Encoder | [symbol] ₕ ( [symbol] ; θₕₑ) |
| Hyper-latents | [symbol] |
| Hyper-latents (quant.) | [symbol] |
| Hyper Decoder | [symbol] ₕ ( [symbol] ; θ_{hd}) |
| Context Model | [symbol] _{cm} ( [symbol] _{<i}; θ_{cm}) |
| Entropy Parameters | [symbol] ₑₚ (•; θₑₚ) |
| Reconstruction | [symbol] |

The combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The dashed region corresponds to the components that are executed by the receiver (e.g, a decoder) to recover an image from a compressed bitstream.

An example system utilizes a joint architecture where both a hyperprior model subnetwork (hyper encoder and hyper decoder) and a context model subnetwork are utilized. The hyperprior and the context model are combined to learn a probabilistic model over quantized latents ŷ, which is then used for entropy coding. As depicted in FIG. 4, the outputs of the context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

The design in FIG. 4. corresponds an example combined compression method. In this section and the next, the encoding and decoding processes are described separately.

In an example, the latent samples are modeled as gaussian distribution or gaussian mixture models (not limited to). According to FIG. 4, the context model and hyperprior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5 The Encoding Process Using Joint Auto-Regressive Hyper Prior Model

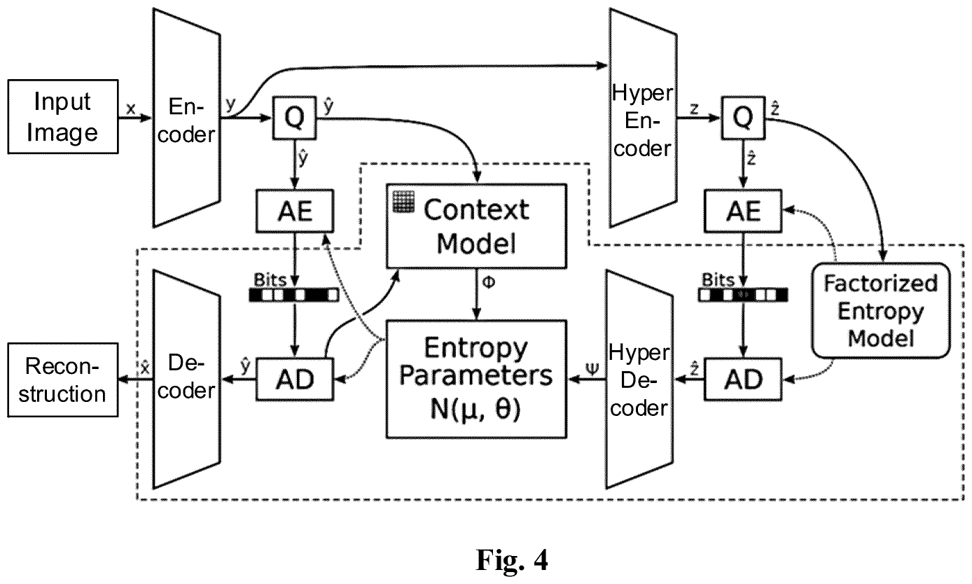

FIG. 5 illustrates an example encoding process. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. the latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. The entropy parameters module are used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).

Finally, the first and the second bitstream are transmitted to the decoder as result of the encoding process. It is noted that the other names can be used for the modules described above.

In the above description, all of the elements in FIG. 5 are collectively called an encoder. The analysis transform that converts the input image into latent representation is also called an encoder (or auto-encoder).

### 2.3.6 The Decoding Process Using Joint Auto-Regressive Hyper Prior Model

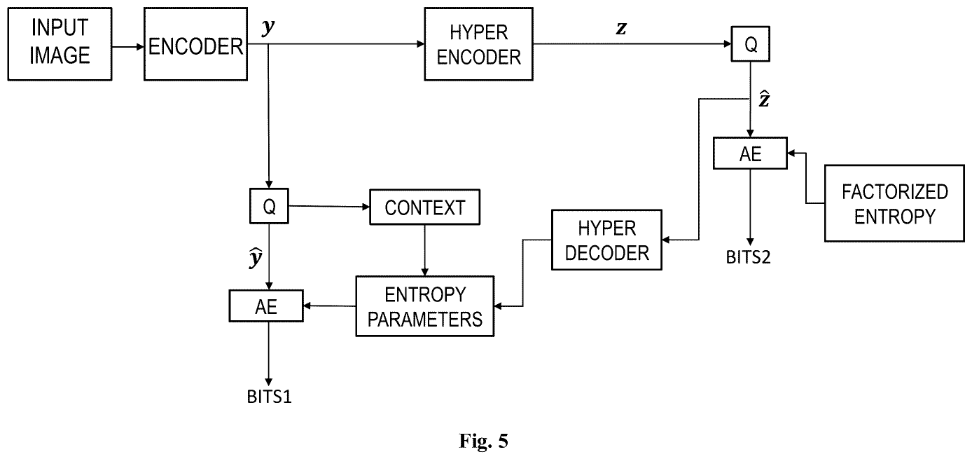

FIG. 6 illustrates an example decoding process. FIG. 6 depicts a decoding process separately.

In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore, the exact same probability distributions can be obtained in the decoder (as in encoder), which is essential for reconstructing the quantized latent ŷ without any loss. As a result, the identical version of the quantized latent ŷ that was obtained in the encoder can be obtained in the decoder.

After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization. Finally, the fully reconstructed quantized latent ŷ is input to the synthesis transform (denoted as decoder in FIG. 6) module to obtain the reconstructed image.

In the above description, the all of the elements in FIG. 6 are collectively called decoder. The synthesis transform that converts the quantized latent into reconstructed image is also called a decoder (or auto-decoder).

### 2.4 Neural Networks for Video Compression

Similar to video coding technologies, neural image compression serves as the foundation of intra compression in neural network-based video compression. Thus, development of neural network-based video compression technology is behind development of neural network-based image compression because neural network-based video compression technology is of greater complexity and hence needs far more effort to solve the corresponding challenges. Compared with image compression, video compression needs efficient methods to remove inter-picture redundancy. Inter-picture prediction is then a major step in these example systems. Motion estimation and compensation is widely adopted in video codecs, but is not generally implemented by trained neural networks.

Neural network-based video compression can be divided into two categories according to the targeted scenarios: random access and the low-latency. In random access case, the system allows decoding to be started from any point of the sequence, typically divides the entire sequence into multiple individual segments, and allows each segment to be decoded independently. In a low-latency case, the system aims to reduce decoding time, and thereby temporally previous frames can be used as reference frames to decode subsequent frames.

### 2.4.1 Low-Latency

An example system first splits the video sequence frames into blocks and each block is coded according to an intra coding mode or an inter coding mode. If intra coding is selected, there is an associated auto-encoder to compress the block. If inter coding is selected, motion estimation and compensation are performed and a trained neural network is used for residue compression. The outputs of auto-encoders are directly quantized and coded by the Huffman method.

Another neural network-based video coding scheme employs PixelMotionCNN. The frames are compressed in the temporal order, and each frame is split into blocks which are compressed in the raster scan order. Each frame is first extrapolated with the preceding two reconstructed frames. When a block is to be compressed, the extrapolated frame along with the context of the current block are fed into the PixelMotionCNN to derive a latent representation. Then the residues are compressed by a variable rate image scheme. This scheme performs on par with H.264.

Another example system employs an end-to-end neural network-based video compression framework, in which all the modules are implemented with neural networks. The scheme accepts a current frame and a prior reconstructed frame as inputs. An optical flow is derived with a pre-trained neural network as the motion information. The motion information is warped with the reference frame followed by a neural network generating the motion compensated frame. The residues and the motion information are compressed with two separate neural auto-encoders. The whole framework is trained with a single rate-distortion loss function. The example system achieves better performance than H.264.

Another example system employs an advanced neural network-based video compression scheme. The system inherits and extends video coding schemes with neural networks with the following major features. First the system uses only one auto-encoder to compress motion information and residues. Second, the system uses motion compensation with multiple frames and multiple optical flows. Third, the system uses an on-line state that is learned and propagated through the following frames over time. This scheme achieves better performance in MS-SSIM than HEVC reference software.

Another example system uses an extended end-to-end neural network-based video compression framework. In this example, multiple frames are used as references. The example system is thereby able to provide more accurate prediction of a current frame by using multiple reference frames and associated motion information. In addition, a motion field prediction is deployed to remove motion redundancy along temporal channel. Postprocessing networks are also used to remove reconstruction artifacts from previous processes. The performance of this system is better than H.265 by a noticeable margin in terms of both PSNR and MS-SSIM.

Another example system uses scale-space flow to replace an optical flow by adding a scale parameter. This example system may achieve better performance than H.264. Another example system uses a multi-resolution representation for optical flows. Concretely, the motion estimation network produces multiple optical flows with different resolutions and let the network learn which one to choose under the loss function. The performance is better than H.265.

### 2.4.2 Random Access

A frame interpolation is employed in another example. The key frames are first compressed with a neural image compressor and the remaining frames are compressed in a hierarchical order. The system performs motion compensation in the perceptual domain by deriving the feature maps at multiple spatial scales of the original frame and using motion to warp the feature maps. The results are used for the image compressor. The method is on par with H.264.

An example system uses a method for interpolation-based video compression. The interpolation model combines motion information compression and image synthesis. The same auto-encoder is used for image and residual. Another example system employs a neural network-based video compression method based on variational auto-encoders with a deterministic encoder. Concretely, the model includes an auto-encoder and an auto-regressive prior. Different from previous methods, this system accepts a group of pictures (GOP) as inputs and incorporates a three dimensional (3D) autoregressive prior by taking into account of the temporal correlation while coding the latent representations. This system provides comparative performance as H.265.

### 2.5 Preliminaries

Almost all the natural image and/or video is in digital format. A grayscale digital image can be represented by x∈ [symbol] , where [symbol] is the set of values of a pixel, m is the image height, and n is the image width. For example, [symbol] ={0, 1, 2, . . . , 255} is an example setting, and in this case | [symbol] |=256=2⁸. Thus, the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] with three separate channels storing Red, Green, and Blue information. Similar to the 8-bit grayscale image, an uncompressed 8-bit RGB image has 24 bpp. Digital images/videos can be represented in different color spaces. The neural network-based video compression schemes are mostly developed in RGB color space while the video codecs typically use a YUV color space to represent the video sequences. In YUV color space, an image is decomposed into three channels, namely luma (Y), blue difference chroma (Cb) and red difference chroma (Cr). Y is the luminance component and Cb and Cr are the chroma components. The compression benefit to YUV occur because Cb and Cr are typically down sampled to achieve pre-compression since human vision system is less sensitive to chroma components.

A color video sequence is composed of multiple color images, also called frames, to record scenes at different timestamps. For example, in the RGB color space, a color video can be denoted by X={x₀, x₁, . . . , xₜ, . . . , x_{T-1}} where T is the number of frames in a video sequence and x∈ [symbol] . If m=1080, n=1920, | [symbol] |=2⁸ and the video has 50 frames-per-second (fps), then the datarate of this uncompressed video is 1920×1080×8×3×50=2,488,320,000 bits-per-second (bps). This results in about 2.32 gigabits per second (Gbps), which uses a lot storage and should be compressed before transmission over the internet.

Usually the lossless methods can achieve a compression ratio of about 1.5 to 3 for natural images, which is clearly below streaming requirements. Therefore, lossy compression is employed to achieve a better compression ratio, but at the cost of incurred distortion. The distortion can be measured by calculating the average squared difference between the original image and the reconstructed image, for example based on MSE. For a grayscale image, MSE can be calculated with the following equation.

$$MSE = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$PSNR = 10 \times {log}_{10} \frac{{( max ( 𝔻 ) )}^{2}}{MSE} \qquad ( 5 )$$

where max( [symbol] ) is the maximal value in [symbol] , e.g., 255 for 8-bit grayscale images. There are other quality evaluation metrics such as structural similarity (SSIM) and multi-scale SSIM (MS-SSIM).
To compare different lossless compression schemes, the compression ratio given the resulting rate, or vice versa, can be compared. However, to compare different lossy compression methods, the comparison has to take into account both the rate and reconstructed quality. For example, this can be accomplished by calculating the relative rates at several different quality levels and then averaging the rates. The average relative rate is known as Bjontegaard's delta-rate (BD-rate). There are other aspects to evaluate image and/or video coding schemes, including encoding/decoding complexity, scalability, robustness, and so on.

### 2.5.1 Pixel Shuffle

Pixel shuffle (may be denoted as PixelShuffle or PS in the following sections) is an operation used in super-resolution models to implement efficient sub-pixel convolutions with a stride of

$$\frac{1}{r} .$$

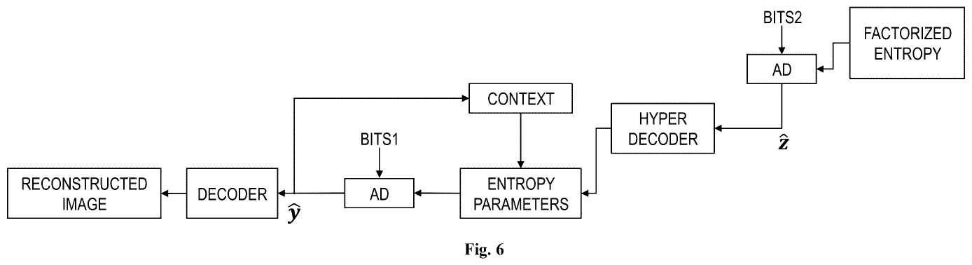

FIG. 7 illustrates an example of pixel shuffle with r=2. As shown in FIG. 7, it arranges elements in a tensor of shape (*, C×r², H, W) to a tensor of shape (*, C, H×r, W×r).

### 2.5.2 Group Convolution

The core of Group Convolution (GC) is to split the filters (learned weights) into groups and apply convolution using each of the grouped filter followed by concatenation of output feature maps. It is used in reducing memory and computational complexity. For example, we define the input feature map size is c₁×H×W, where c₁ is the channel number of the input feature maps. Then the filter size is c₂×c₁×h₁×w₁, where c₂ is the number of output channel number, h₁ and w₁ are the filter kernel height and width, respectively.

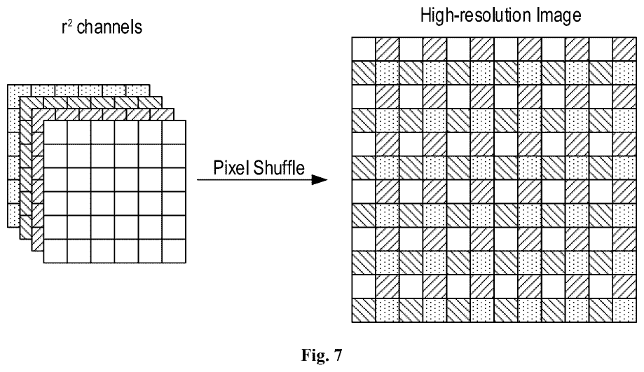

In the normal convolution operation as illustrated in FIG. 8, the filter number of parameters is c₂×c₁×h₁×w₁.

FIG. 8 illustrates an example convolutional layer, with two smaller blocks representing learned parameters and two larger blocks representing feature maps.

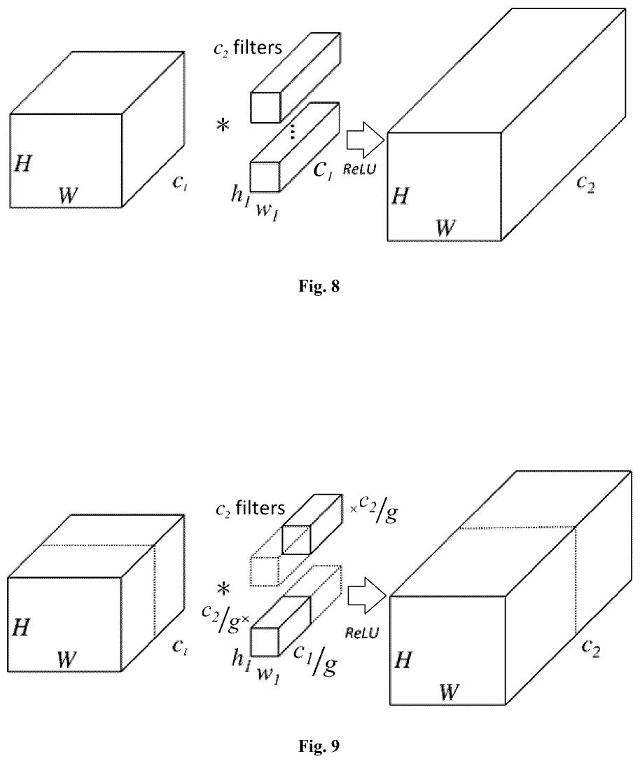

FIG. 9 illustrates an example convolutional layer with 2 groups (Group Convolution). Each of the filters in the grouped convolutional layer is now exactly half of the depth, i.e., half the parameters and half the computational operations.

FIG. 9 shows an example of the Group Convolution with 2 groups. The operation becomes equivalent to having two conv layers side by side, each seeing half the input channels and producing half the output channels, and both subsequently concatenated. The convolutional filter depth is reduced to half the size but with 2 groups, and each group includes c₂/2 channels. In this case, the total number of filter parameters becomes:

$$\frac{1}{2} {c}_{2} \times \frac{1}{2} {c}_{1} \times {h}_{1} \times {w}_{1} + \frac{1}{2} {c}_{2} \times \frac{1}{2} {c}_{1} \times {h}_{1} \times {w}_{1} ,$$

which is half the number of parameters compared to normal convolution as shown in FIG. 9. So if the group number is N with no convolutional kernel size change, the number of parameters is

$$\frac{1}{N}$$

of normal convolution.

### 3. Technical Problems Solved by Disclosed Technical Solutions

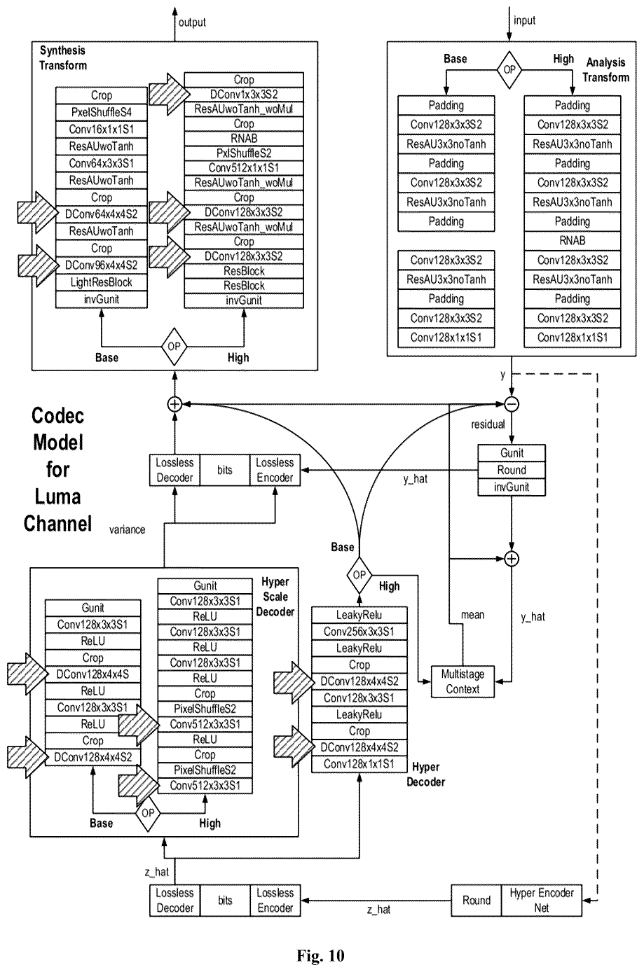

As illustrated in FIG. 10, the end-to-end image compression code comprises the following main networks analysis transform, synthesis transform, hyper encoder, hyper decoder, hyper scale decoder and multi-stage context model. This image codec has two operating points base and high. The base operation point has simpler design aiming at low-complexity scenarios, while the high operating point has better coding performance but heavy computational complexity. In this framework, there are multiple networks that include upsampling operations, hyper scale decoder (base and high), hyper decoder and two synthesis transforms (base and high). The upsampling operations are implemented as in Table 2 and highlighted in FIG. 10 with arrows.

TABLE 2
The upsampling implementations in existing framework.

| Network Name | Position | Upsampling implementation |
|---|---|---|
| Hyper Decoder (base) | 2^{nd} and 4^{th} layers | 4 × 4 Transposed convolution, stride of 2. |
| Hyper Scale Decoder (base) | 1^{st} and 3^{rd} layers | 4 × 4 Transposed convolution, stride of 2. |
| Hyper Scale Decoder (high) | 1^{st} and 2^{nd} layers | 3 × 3 convolution + PixelShuffle |
| Synthesis transform (base) | 2^{nd} and 3^{rd} layers | 4 × 4 Transposed convolution, stride of 2. |
| Synthesis transform (high) | 3^{rd} and 4^{th} layers | 3 × 3 Transposed convolution, stride of 2. |

FIG. 10 illustrates an example end-to-end neural network image compression framework. The end-to-end neural network image compression framework is for Luma component with upsampling layers highlighted with shaded arrows in Hyper Scale Decoder, Hyper Decoder and Synthesis transforms (base and high).

The design has the following drawbacks.
1) The framework has multiple types of upsampling implementation units which makes the framework complex and costly to maintain.
2) The heavily used transposed convolution is not the optimal unit for upsampling, and it is not friendly for hardware implementations.

### 4. A Listing of Solutions and Embodiments

The detailed aspects below should be considered as examples to explain general concepts. These examples should not be interpreted in a narrow way. Furthermore, these examples can be combined in any manner.

### 4.1 Specific Examples

The target of the disclosure is to provide a unified upsampling implementation for the end-to-end image codec. In the ideal case, all the upsampling components are implemented in the same way, such as pixel shuffle, transposed convolution or any other methods. The principle should be the best trade-off of coding gain and computational complexity. The computational complexity may be decoding time, kMac/pixel or other metrics in a specific scenario. However, when the coding performance (for example BDRate) degrades, it is considerable to apply changes only to partial of these upsampling positions.

### Further Examples

1. Whether to and/or how to apply the disclosed methods above may be signalled at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.
2. Whether to and/or how to apply the disclosed methods above may be dependent on coded information, such as block size, colour format, single/dual tree partitioning, colour component, slice/picture type.
3. The proposed methods disclosed in this document may be used in other coding tools which require chroma fusion.
4. A syntax element disclosed above may be binarized as a flag, a fixed length code, an EG(x) code, a unary code, a truncated unary code, a truncated binary code, etc. It can be signed or unsigned.
5. A syntax element disclosed above may be coded with at least one context model. Or it may be bypass coded.
6. A syntax element disclosed above may be signaled in a conditional way.
   a. The SE is signaled only if the corresponding function is applicable.
   b. The SE is signaled only if the dimensions (width and/or height) of the block satisfy a condition.
7. A syntax element disclosed above may be signaled at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.

### 5. Embodiments

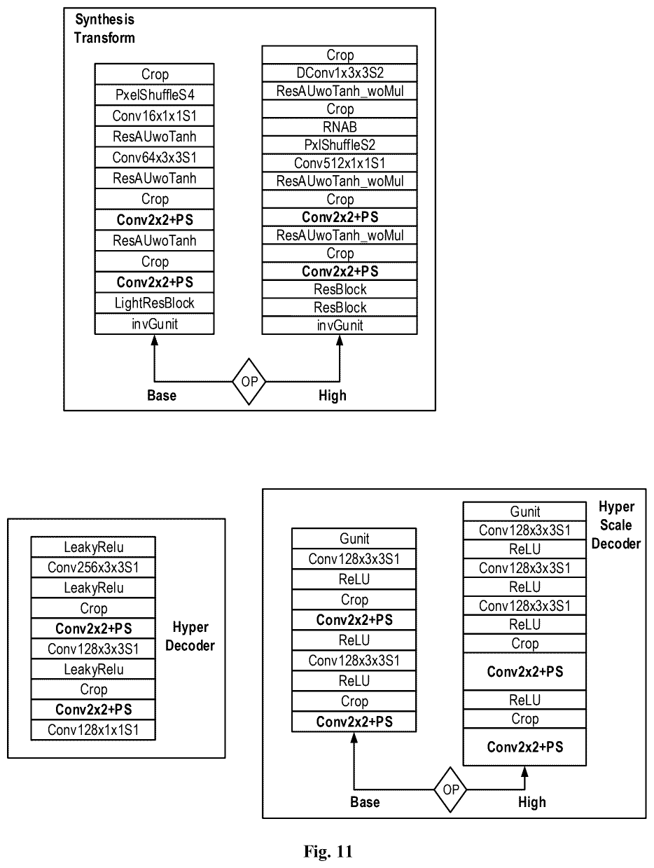

FIG. 11 illustrates an example with all upsampling units listed in Table 2 implemented with 2×2 convolution with pixel shuffle.

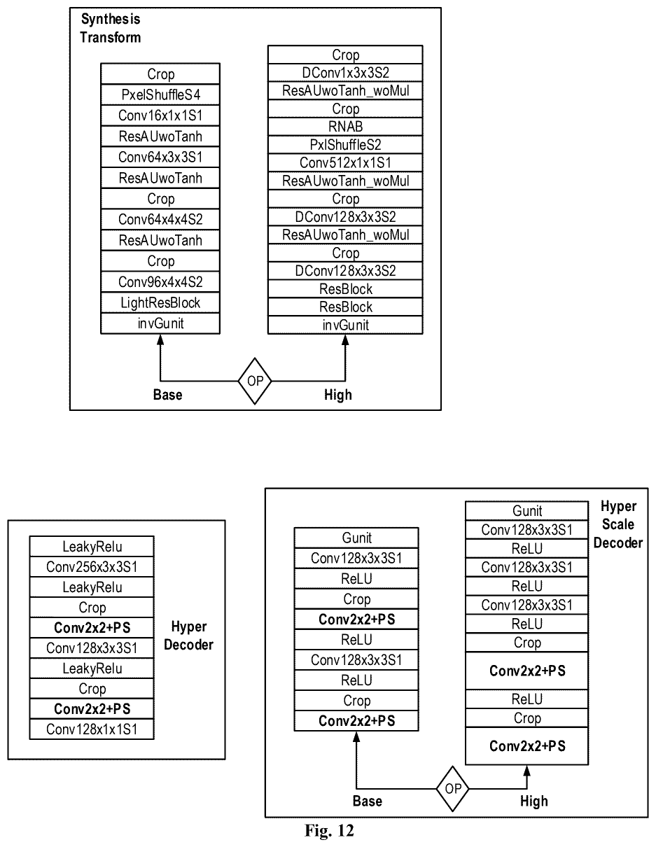

FIG. 12 illustrates an example 2×2 convolution with pixel shuffle is applied to Hyper Scale Decoder (base and high) and Hyper Decoder.

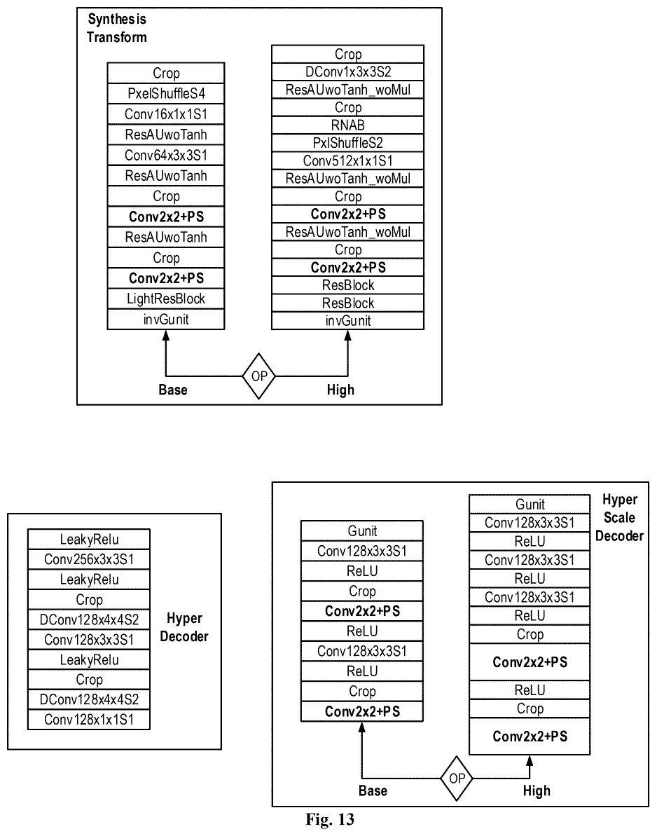

FIG. 13 illustrates an example 2×2 convolution with pixel shuffle is applied to Hyper Scale Decoder (base and high) and synthesis transforms (base and high).

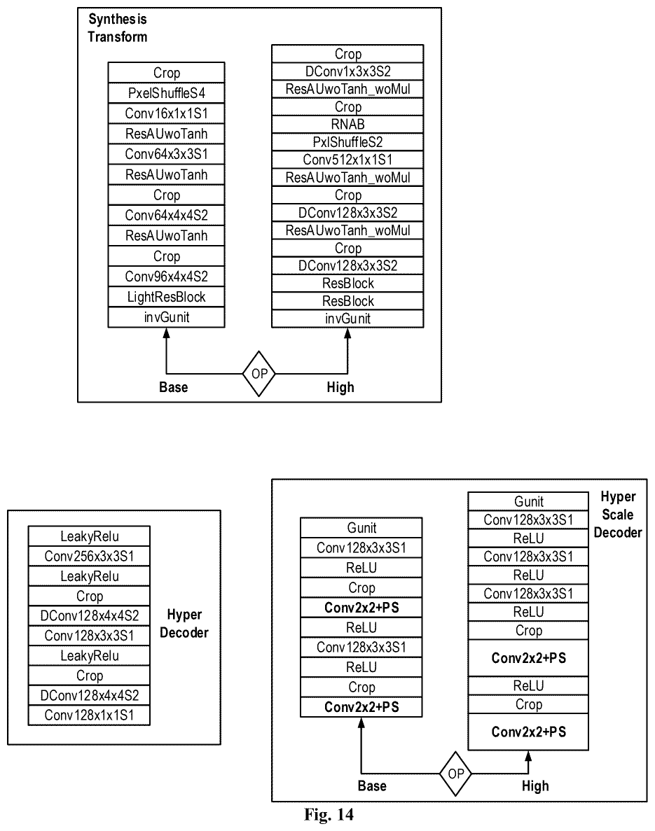

FIG. 14 illustrates an example 2×2 convolution with pixel shuffle is applied to Hyper Scale Decoder (base and high).
1. In one example, all the upsampling listed in Table 2 are replaced with 2×2 convolution with pixel shuffle r=2, as shown in FIG. 11.
2. In one example, only the upsampling units listed in Table 2 of Hyper Decoder and Hyper Scale Decoder (base and high) are replaced with 2×2 convolution with pixel shuffle r=2, as shown in FIG. 12.
3. In one example, only the upsampling units listed in Table 2 of Hyper Scale Decoder (base and high) and synthesis transforms (base and high) are replaced with 2×2 convolution with pixel shuffle r=2, as shown in FIG. 13.
4. In one example, only the upsampling units listed in Table 2 of Hyper Scale Decoder (base and high) are replaced with 2×2 convolution with pixel shuffle r=2, as shown in FIG. 14.
5. Alternatively, in the above bullets 1-4, the 2×2 convolution with pixel shuffle r=2 may be the following alternative units.
   a. A 2×2 convolution with pixel shuffle of r=4.
   b. A 3×3 convolution with pixel shuffle of r=2.
   c. A 3×3 convolution with pixel shuffle of r=4.
   d. A 4×4 transposed convolution with stride of 2.
   e. A 3×3 transposed convolution with stride of 2.
   f. A 2×2 transposed convolution with stride of 2.

More details of the embodiments of the present disclosure will be described below which are related to neural network-based visual data coding. As used herein, the term “visual data” may refer to a video, an image, a picture in a video, or any other visual data suitable to be coded.

As discussed above, in the existing design for neural network (NN)-based visual data coding, upsampling components in the NN-based model are implemented with multiple types of structures, which makes the NN-based model complex and costly to maintain.

To solve the above problems and some other problems not mentioned, visual data processing solutions as described below are disclosed. The embodiments of the present disclosure should be considered as examples to explain the general concepts and should not be interpreted in a narrow way. Furthermore, these embodiments can be applied individually or combined in any manner.

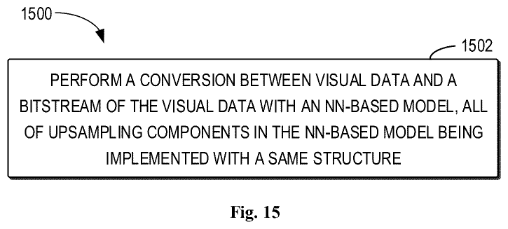

FIG. 15 illustrates a flowchart of a method 1500 for visual data processing in accordance with some embodiments of the present disclosure. At 1502, a conversion between visual data and a bitstream of the visual data is performed with a neural network (NN)-based model. In some embodiments, the conversion may include encoding the visual data into the bitstream. Additionally or alternatively, the conversion may include decoding the visual data from the bitstream. The scope of the present disclosure is not limited in this respect.

As used herein, an NN-based model may be a model based on neural network technologies. For example, an NN-based model may specify sequence of neural network modules (also called architecture) and model parameters. The neural network module may comprise a set of neural network layers. Each neural network layer specifies a tensor operation which receives and outputs tensor, and each layer has trainable parameters. In some embodiments, the NN-based model may be an end-to-end visual data codec. It should be understood that the possible implementations of the NN-based model described here are merely illustrative and therefore should not be construed as limiting the present disclosure in any way.

In addition, all of upsampling components in the NN-based model are implemented with a same structure. For example, all of upsampling components in the NN-based model are implemented in the same manner. In some embodiments, the same structure for implementing the upsampling components may comprise a convolution with a pixel shuffle. For example, a upsampling scale factor (denoted as “r”) of the pixel shuffle may be larger than 1, such as 2, 4, or the like. Additionally or alternatively, a kernel size of the convolution may be 2×2, 3×3, 4×4, or the like.

In some additional or alternative embodiments, the same structure for implementing the upsampling components may comprise a transposed convolution. For example, a stride of the transposed convolution may be larger than 1, such as 2, 4 or the like. Additionally or alternatively, a kernel size of the transposed convolution may be 2×2, 3×3, 4×4, or the like. It should be understood that the specific values recited herein are intended to be exemplary rather than limiting the scope of the present disclosure, and the upsampling components may implemented in any other suitable manner. The scope of the present disclosure is not limited in this respect.

In view of the above, all of upsampling components in the NN-based model are implemented with a same structure. Compared with the conventional solution where upsampling components in the NN-based model are implemented with multiple types of structures, the proposed method can advantageously unify the implementation of upsampling components in the NN-based model, and thus simplify the implementation of the NN-based model. Thereby, the coding efficiency can be improved.

In some embodiments, the NN-based model may comprise at least one of the following: a synthesis transform sub-model, a hyper decoder sub-model, or a hyper scale decoder sub-model. For example, the hyper decoder sub-model may be used to derive the part of prediction tensor from explicitly signalled information, and the hyper scale decoder sub-model may be used to derive a probability distribution parameter (such as a standard deviation logarithm tensor, or the like) from reconstructed hyper tensor. By way of example, with reference to FIG. 11, all of upsampling components in the synthesis transform, hyper decoder and hyper scale decoder are implemented with a 2×2 convolution with pixel shuffle, and the upsampling scale factor r is equal to 2.

In some alternative embodiments, instead of all upsampling components, only a part of upsampling components in the NN-based model may be implemented with the same structure, which may be determined based on a trade-off of coding gain and computational complexity. A metric for the computational complexity may be decoding time, kilo multiplication-accumulation per pixel (kMac/pixel) or the like. For example, only upsampling components comprised in one or more specific sub-model of the NN-base model may be implemented with the same structure.

By way of example, with reference to FIG. 12, all of upsampling components in the hyper decoder and hyper scale decoder are uniformly implemented with a 2×2 convolution with pixel shuffle. With reference to FIG. 13, all of upsampling components in the synthesis transform, and hyper scale decoder are uniformly implemented with a 2×2 convolution with pixel shuffle. With reference to FIG. 13, all of upsampling components in the hyper scale decoder are uniformly implemented with a 2×2 convolution with pixel shuffle. It should be understood that the above examples are described merely for purpose of description. The scope of the present disclosure is not limited in this respect.

In some embodiments, first information regarding at least one of the following may be indicated in the bitstream: whether all of upsampling components in the NN-based model are implemented with the same structure, or how to implement all of upsampling components in the NN-based model. For example, the first information may be indicated at a block level, a sequence level, a group of pictures level, a picture level, a slice level, a tile group level, or the like.

In some embodiments, the first information may be indicated in a coding structure of a coding tree unit (CTU), a coding structure of a coding unit (CU), a coding structure of a transform unit (TU), a coding structure of a prediction unit (PU), a coding structure of a coding tree block (CTB), a coding structure of a coding block (CB), a coding structure of a transform block (TB), a coding structure of a prediction block (PB), a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, a tile group header, or the like.

In some embodiments, the first information may be dependent on coded information of the visual data. By way of example, the coded information may comprise a block size, a color format, a single tree partitioning, a dual tree partitioning, a color component, a slice type, a picture type, and/or the like.

In some embodiments, the first information may be indicated by a syntax element. For example, the syntax element may be binarized as a flag, a fixed length code, an exponential Golomb (EG) code, a unary code, a truncated unary code, a truncated binary code, or the like. Additionally or alternatively, the syntax element may be coded with at least one context model. Alternatively, the syntax element may be bypass coded.

In some embodiments, a syntax element indicating at least one of the following may be signaled based on a condition: whether all of upsampling components in the NN-based model may be implemented with the same structure, or how to implement all of upsampling components in the NN-based model. By way of example rather than limitation, if a size of the visual data is larger than a threshold, the syntax element is signalled.

In view of the above, the solutions in accordance with some embodiments of the present disclosure can advantageously unify the implementation of upsampling components in the NN-based model, and thus simplify the implementation of the NN-based model. Thereby, the coding efficiency can be improved.

According to further embodiments of the present disclosure, a non-transitory computer-readable recording medium is provided. The non-transitory computer-readable recording medium stores a bitstream of visual data which is generated by a method performed by an apparatus for visual data processing. In the method, a conversion between visual data and a bitstream of the visual data is performed with a neural network (NN)-based model. All of upsampling components in the NN-based model are implemented with a same structure.

According to still further embodiments of the present disclosure, a method for storing bitstream of visual data is provided. In the method, a conversion between visual data and a bitstream of the visual data is performed with a neural network (NN)-based model. All of upsampling components in the NN-based model are implemented with a same structure. Moreover, the bitstream is stored in a non-transitory computer-readable recording medium.

Implementations of the present disclosure can be described in view of the following clauses, the features of which can be combined in any reasonable manner.

Clause 1. A method for visual data processing, comprising: performing a conversion between visual data and a bitstream of the visual data with a neural network (NN)-based model, all of upsampling components in the NN-based model being implemented with a same structure.

Clause 2. The method of clause 1, wherein the same structure comprises a convolution with a pixel shuffle.

Clause 3. The method of clause 2, wherein a upsampling scale factor of the pixel shuffle is larger than 1.

Clause 4. The method of any of clauses 2-3, wherein a kernel size of the convolution is one of the following: 2×2, 3×3, or 4×4.

Clause 5. The method of any of clauses 1-4, wherein the same structure comprises a transposed convolution.

Clause 6. The method of clause 5, wherein a stride of the transposed convolution is larger than 1.

Clause 7. The method of any of clauses 5-6, wherein a kernel size of the transposed convolution is one of the following: 2×2, 3×3, or 4×4.

Clause 8. The method of any of clauses 1-7, wherein the NN-based model comprises at least one of the following: a synthesis transform sub-model, a hyper decoder sub-model, or a hyper scale decoder sub-model.

Clause 9. The method of any of clauses 1-8, wherein first information regarding at least one of the following is indicated in the bitstream: whether all of upsampling components in the NN-based model are implemented with the same structure, or how to implement all of upsampling components in the NN-based model.

Clause 10. The method of clause 9, wherein the first information is indicated at one of the following: a block level, a sequence level, a group of pictures level, a picture level, a slice level, or a tile group level.

Clause 11. The method of clause 9, wherein the first information is indicated in one of the following: a coding structure of a coding tree unit (CTU), a coding structure of a coding unit (CU), a coding structure of a transform unit (TU), a coding structure of a prediction unit (PU), a coding structure of a coding tree block (CTB), a coding structure of a coding block (CB), a coding structure of a transform block (TB), a coding structure of a prediction block (PB), a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 12. The method of any of clauses 9-11, wherein the first information is dependent on coded information of the visual data.

Clause 13. The method of clause 12, wherein the coded information comprises at least one of the following: a block size, a color format, a single tree partitioning, a dual tree partitioning, a color component, a slice type, or a picture type.

Clause 14. The method of any of clauses 9-13, wherein the first information is indicated by a syntax element.

Clause 15. The method of clause 14, wherein the syntax element is binarized as one of the following: a flag, a fixed length code, an exponential Golomb (EG) code, a unary code, a truncated unary code, or a truncated binary code.

Clause 16. The method of any of clauses 14-15, wherein the syntax element is coded with at least one context model, or wherein the syntax element is bypass coded.

Clause 17. The method of any of clauses 1-8, wherein a syntax element indicating at least one of the following is signaled based on a condition: whether all of upsampling components in the NN-based model are implemented with the same structure, or how to implement all of upsampling components in the NN-based model.

Clause 18. The method of any of clauses 1-17, wherein the visual data comprise a video, a picture of the video, or an image.

Clause 19. The method of any of clauses 1-18, wherein the conversion includes encoding the visual data into the bitstream.

Clause 20. The method of any of clauses 1-18, wherein the conversion includes decoding the visual data from the bitstream.

Clause 21. An apparatus for visual data processing comprising a processor and a non-transitory memory with instructions thereon, wherein the instructions upon execution by the processor, cause the processor to perform a method in accordance with any of clauses 1-20.

Clause 22. A non-transitory computer-readable storage medium storing instructions that cause a processor to perform a method in accordance with any of clauses 1-20.

Clause 23. A non-transitory computer-readable recording medium storing a bitstream of visual data which is generated by a method performed by an apparatus for visual data processing, wherein the method comprises: performing a conversion between visual data and a bitstream of the visual data with a neural network (NN)-based model, all of upsampling components in the NN-based model being implemented with a same structure.

Clause 24. A method for storing a bitstream of visual data, comprising: generating the bitstream of the visual data with a neural network (NN)-based model, all of upsampling components in the NN-based model being implemented with a same structure; and storing the bitstream in a non-transitory computer-readable recording medium.

### Example Device

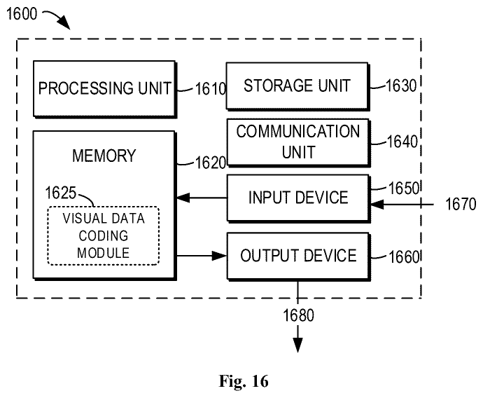

FIG. 16 illustrates a block diagram of a computing device 1600 in which various embodiments of the present disclosure can be implemented. The computing device 1600 may be implemented as or included in the source device 110 (or the visual data encoder 114) or the destination device 120 (or the visual data decoder 124).

It would be appreciated that the computing device 1600 shown in FIG. 16 is merely for purpose of illustration, without suggesting any limitation to the functions and scopes of the embodiments of the present disclosure in any manner.

As shown in FIG. 16, the computing device 1600 includes a general-purpose computing device 1600. The computing device 1600 may at least comprise one or more processors or processing units 1610, a memory 1620, a storage unit 1630, one or more communication units 1640, one or more input devices 1650, and one or more output devices 1660.

In some embodiments, the computing device 1600 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1600 can support any type of interface to a user (such as “wearable” circuitry and the like).

The processing unit 1610 may be a physical or virtual processor and can implement various processes based on programs stored in the memory 1620. In a multi-processor system, multiple processing units execute computer executable instructions in parallel so as to improve the parallel processing capability of the computing device 1600. The processing unit 1610 may also be referred to as a central processing unit (CPU), a microprocessor, a controller or a microcontroller.

The computing device 1600 typically includes various computer storage medium. Such medium can be any medium accessible by the computing device 1600, including, but not limited to, volatile and non-volatile medium, or detachable and non-detachable medium. The memory 1620 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1630 may be any detachable or non-detachable medium and may include a machine-readable medium such as a memory, flash memory drive, magnetic disk or another other media, which can be used for storing information and/or visual data and can be accessed in the computing device 1600.

The computing device 1600 may further include additional detachable/non-detachable, volatile/non-volatile memory medium. Although not shown in FIG. 16, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more visual data medium interfaces.

The communication unit 1640 communicates with a further computing device via the communication medium. In addition, the functions of the components in the computing device 1600 can be implemented by a single computing cluster or multiple computing machines that can communicate via communication connections. Therefore, the computing device 1600 can operate in a networked environment using a logical connection with one or more other servers, networked personal computers (PCs) or further general network nodes.

The input device 1650 may be one or more of a variety of input devices, such as a mouse, keyboard, tracking ball, voice-input device, and the like. The output device 1660 may be one or more of a variety of output devices, such as a display, loudspeaker, printer, and the like. By means of the communication unit 1640, the computing device 1600 can further communicate with one or more external devices (not shown) such as the storage devices and display device, with one or more devices enabling the user to interact with the computing device 1600, or any devices (such as a network card, a modem and the like) enabling the computing device 1600 to communicate with one or more other computing devices, if required. Such communication can be performed via input/output (I/O) interfaces (not shown).

In some embodiments, instead of being integrated in a single device, some or all components of the computing device 1600 may also be arranged in cloud computing architecture. In the cloud computing architecture, the components may be provided remotely and work together to implement the functionalities described in the present disclosure. In some embodiments, cloud computing provides computing, software, visual data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding visual data may be stored on a server at a remote position. The computing resources in the cloud computing environment may be merged or distributed at locations in a remote visual data center. Cloud computing infrastructures may provide the services through a shared visual data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1600 may be used to implement visual data encoding/decoding in embodiments of the present disclosure. The memory 1620 may include one or more visual data coding modules 1625 having one or more program instructions. These modules are accessible and executable by the processing unit 1610 to perform the functionalities of the various embodiments described herein.

In the example embodiments of performing visual data encoding, the input device 1650 may receive visual data as an input 1670 to be encoded. The visual data may be processed, for example, by the visual data coding module 1625, to generate an encoded bitstream. The encoded bitstream may be provided via the output device 1660 as an output 1680.

In the example embodiments of performing visual data decoding, the input device 1650 may receive an encoded bitstream as the input 1670. The encoded bitstream may be processed, for example, by the visual data coding module 1625, to generate decoded visual data. The decoded visual data may be provided via the output device 1660 as the output 1680.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

1. A method for visual data processing, comprising:
performing a conversion between visual data and a bitstream of the visual data with a neural network (NN)-based model, all of upsampling components in the NN-based model being implemented with a same structure.

2. The method of claim 1, wherein the same structure comprises a convolution with a pixel shuffle.

3. The method of claim 2, wherein a upsampling scale factor of the pixel shuffle is larger than 1.

4. The method of claim 2, wherein a kernel size of the convolution is one of the following: 2×2, 3×3, or 4×4.

5. The method of claim 1, wherein the same structure comprises a transposed convolution.

6. The method of claim 5, wherein a stride of the transposed convolution is larger than 1.

7. The method of claim 5, wherein a kernel size of the transposed convolution is one of the following: 2×2, 3×3, or 4×4.

8. The method of claim 1, wherein the NN-based model comprises at least one of the following:
a synthesis transform sub-model,
a hyper decoder sub-model, or
a hyper scale decoder sub-model.

9. The method of claim 1, wherein first information regarding at least one of the following is indicated in the bitstream:
whether all of upsampling components in the NN-based model are implemented with the same structure, or
how to implement all of upsampling components in the NN-based model.

10. The method of claim 9, wherein the first information is indicated at one of the following: a block level, a sequence level, a group of pictures level, a picture level, a slice level, or a tile group level, or
wherein the first information is indicated in one of the following: a coding structure of a coding tree unit (CTU), a coding structure of a coding unit (CU), a coding structure of a transform unit (TU), a coding structure of a prediction unit (PU), a coding structure of a coding tree block (CTB), a coding structure of a coding block (CB), a coding structure of a transform block (TB), a coding structure of a prediction block (PB), a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

11. The method of claim 9, wherein the first information is dependent on coded information of the visual data, and the coded information comprises at least one of the following:
a block size,
a color format,
a single tree partitioning,
a dual tree partitioning,
a color component,
a slice type, or
a picture type.

12. The method of claim 9, wherein the first information is indicated by a syntax element.

13. The method of claim 12, wherein the syntax element is binarized as one of the following: a flag, a fixed length code, an exponential Golomb (EG) code, a unary code, a truncated unary code, or a truncated binary code, or
wherein the syntax element is coded with at least one context model, or
wherein the syntax element is bypass coded.

14. The method of claim 1, wherein a syntax element indicating at least one of the following is signaled based on a condition:
whether all of upsampling components in the NN-based model are implemented with the same structure, or
how to implement all of upsampling components in the NN-based model.

15. The method of claim 1, wherein the visual data comprise a video, a picture of the video, or an image.

16. The method of claim 1, wherein the conversion includes encoding the visual data into the bitstream.

17. The method of claim 1, wherein the conversion includes decoding the visual data from the bitstream.

18. An apparatus for visual data processing comprising a processor and a non-transitory memory with instructions thereon, wherein the instructions upon execution by the processor, cause the processor to perform operations comprising:
performing a conversion between visual data and a bitstream of the visual data with a neural network (NN)-based model, all of upsampling components in the NN-based model being implemented with a same structure.

19. A non-transitory computer-readable storage medium storing instructions that cause a processor to perform operations comprising:
performing a conversion between visual data and a bitstream of the visual data with a neural network (NN)-based model, all of upsampling components in the NN-based model being implemented with a same structure.

20. A non-transitory computer-readable recording medium storing a bitstream of visual data which is generated by a method performed by an apparatus for visual data processing, wherein the method comprises:
performing a conversion between visual data and a bitstream of the visual data with a neural network (NN)-based model, all of upsampling components in the NN-based model being implemented with a same structure.
